(19) United States
(12) Patent Application Publication
(10) Pub. No.: US 2010/0277380 A1
(43) Pub. Date: Nov. 4, 2010

(54) Vehicle Antenna Device Using Space-Filling Curves

(76) Inventor: Richard Breden, Sittingbourne Kent (GB)

Correspondence Address: WELLS ST. JOHN P.S., 601 W. FIRST AVENUE, SUITE 1300, SPOKANE, WA, 99201, US

(21) Appl. No.: 12/769,488

(22) Filed: Apr. 28, 2010

(30) Foreign Application Priority Data
Apr. 30, 2009 (JP) 2009-111504

(51) Int. Cl. H01Q 1/32

(52) U.S. Cl. 343/713

(57) ABSTRACT

The vehicle antenna device disclosed is constituted by space-filling curves. The vehicle antenna device includes an antenna element having space-filling curves that initial shape is constituted by two parallel lines and a slant line continuously connecting therebetween. Specifically, the antenna element has space-filling curves that initial shape has a start point at one end of the one parallel line and an end point at the other end of the other parallel line. More specifically, the antenna element has space-filling curves that initial shape is an N-shape or reversed N-shape.

### RELATED APPLICATION

This application relates to and claims priority from Japanese Patent Application No. 2009-111504 filed on Apr. 30, 2009.

### BACKGROUND OF THE INVENTION

1. Field of the Invention

The present invention relates to a vehicle antenna device, and more particularly to a vehicle antenna device in which at least a part of an antenna element is constituted by space-filling curves.

2. Description of the Related Art

There has conventionally been known a small-sized vehicle antenna device using space-filling curves as an antenna element. The space-filling curves are curves that go through all subintervals obtained by dividing a two-dimensional space in one trip. For example, Patent Document 1 (Japanese PCT National Publication No. 2003-521146) discloses an antenna device using, as the space-filling curves, Hilbert curves or Peano curves. Similarly, Patent Document 2 (Japanese PCT National Publication No. 2008-523671) discloses an antenna device using Hilbert curves or Peano curves. The use of such space-filling curves allows a reduction in the size of the area required for arrangement of the antenna element while suppressing influence of coupling between wirings of the antenna element.

Now, development of an antenna element pattern capable of achieving a further reduction of the area of the antenna element while keeping reception sensitivity characteristics is demanded. Because, if the antenna element is arranged more densely, the size of the area required for arrangement of the antenna element can correspondingly be reduced to increase design flexibility and installation flexibility of the antenna device.

### SUMMARY OF THE INVENTION

The present invention has been made in view of the above situation, and an object thereof is to provide a vehicle antenna device using space-filling curves capable of reducing the size of the area required for arrangement of the antenna element.

To achieve the above object, according to an aspect of the present invention, there is provided a vehicle antenna device comprising an antenna element having space-filling curves that initial shape is constituted by two parallel lines and a slant line continuously connecting therebetween.

The antenna element may have space-filling curves that initial shape has a start point at one end of the one parallel line and an end point at the other end of the other parallel line.

The antenna element may have space-filling curves that initial shape is an N-shape or reversed N-shape.

The antenna element may have slant connecting lines in the space-filling curves.

A target frequency of the antenna element may be made changeable by an extension factor of the space-filling curves.

A target frequency of the antenna element may be made changeable by a line width of the space-filling curves.

The antenna element may have two-stage fifth-order space-filling curves.

In the vehicle antenna device using the space-filling curves according to the present invention, it is possible to reduce the size of the area required for arrangement of the antenna element. Further, if the size of the area required for arrangement of the antenna element is set to a constant value, the length of the antenna element can be increased.

In addition, a desired target frequency can be obtained by adjusting the extension factor of the space-filling curves of the antenna element without the need of increasing or reducing the order number.

### BRIEF DESCRIPTION OF THE DRAWINGS

FIGS. 1A-1C are views for explaining a process of generating space-filling curves used in the present invention;

FIG. 2 is a view showing the fourth-order space-filling curves used in the present invention;

FIG. 3 is a schematic plan view for explaining an antenna element of the vehicle antenna device according to the present invention;

FIG. 4 is a schematic plan view for explaining an example in which the extension factor of the space-filling curves of the antenna element of the vehicle antenna device according to the present invention is made changeable; and

FIG. 5 is a graph showing frequency-to-gain characteristics obtained by simulation using the vehicle antenna device according to the present invention.

### DETAILED DESCRIPTION OF THE PREFERRED EMBODIMENT

A preferred embodiment of the present invention will be described with reference to the accompanying drawings. First, space-filling curves applied to a vehicle antenna device according to the present invention will be described. The space-filling curves are curves that go through all subintervals obtained by dividing a two-dimensional space in one trip. As an order number is increased in a predetermined area, the number of subintervals that the antenna element should go through is increased. In the present specification, the “order number” means the number of divisions of the predetermined area. When the number of divisions is increased, curves including an initial shape are periodically repeated to constitute space-filling curves. Each of the subintervals finally obtained by dividing the predetermined area according to the order number is referred to as a unit cell.

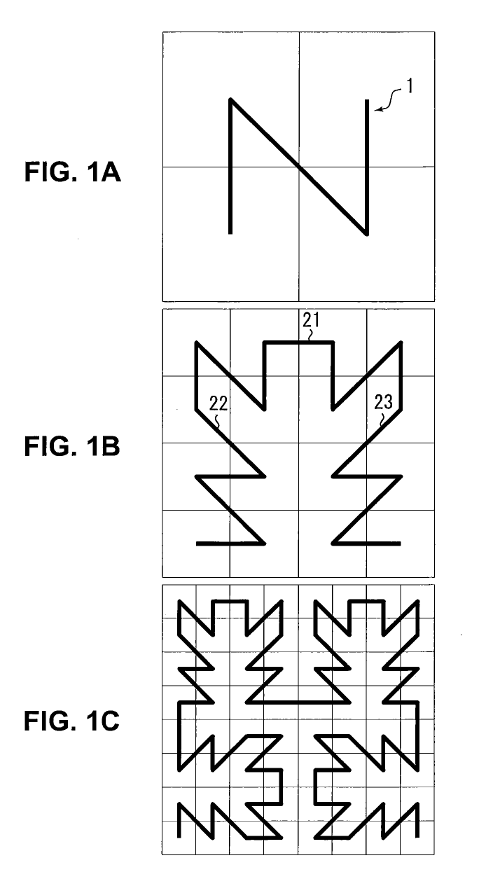

The space-filling curves used in the present invention will be described more specifically below with reference to FIGS. 1A-1C. FIGS. 1A-1C are views for explaining a process of generating the space-filling curves used in the present invention. FIG. 1A shows the first-order curves, FIG. 1B shows the second-order curves, and FIG. 1C shows the third-order curves. As shown in FIG. 1A, an initial shape 1 of the space-filling curves used in the present invention which corresponds to the first-order, i.e., a state where a predetermined area is divided into four subintervals is constituted by two parallel lines and one slant line continuously connecting the two parallel lines. More specifically, the initial shape 1 is constituted by an N-shape. Although the initial shape is the N-shaped curves in the example shown in FIG. 1A, the present invention is not limited to this. For example, the initial shape may be constituted by a reversed N-shape. The feature of the initial shape of the space-filling curves used in the present invention is that the positions of a start point and an end point are inverted, and that a slant line is included.

As shown in FIG. 1B, the second-order curves are obtained by combining the N-shape and reversed N-shape, where these initial shapes (N-shape and reversed N-shape) are connected to each other by connecting lines 21 to 23 to constitute one curve. As shown in FIG. 1C, when the order number is further increased, the number of the unit cells is increased and, correspondingly, the length of the space-filling curves is increased. The generating method of the space-filling curves like this is basically similar to a generating method of Hilbert curves.

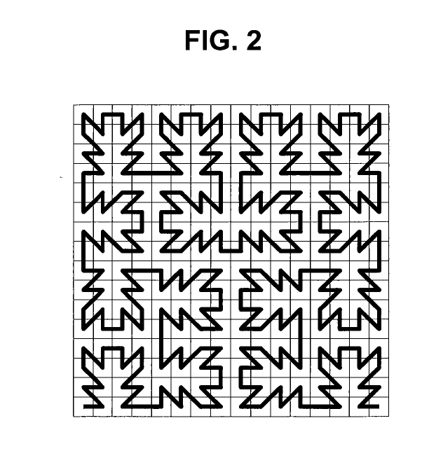

The space-filling curves obtained by repeating the above process up to the fourth-order are shown in FIG. 2. FIG. 2 is a view showing the fourth-order space-filling curves used in the present invention. As shown in FIG. 2, in the space-filling curves used in the present invention, a slant line is included in each initial shape, and slant lines are also used as the connecting lines. Assuming that the length of the vertical line or horizontal line is 1, the length of the slant line becomes a square root of 2. That is, the length of the space-filling curves used in the present invention including the slant lines are longer than that of space-filling curves obtained by combining only the vertical and horizontal lines. Thus, the area required for arrangement of the space-filling curves can be reduced with the same entire length.

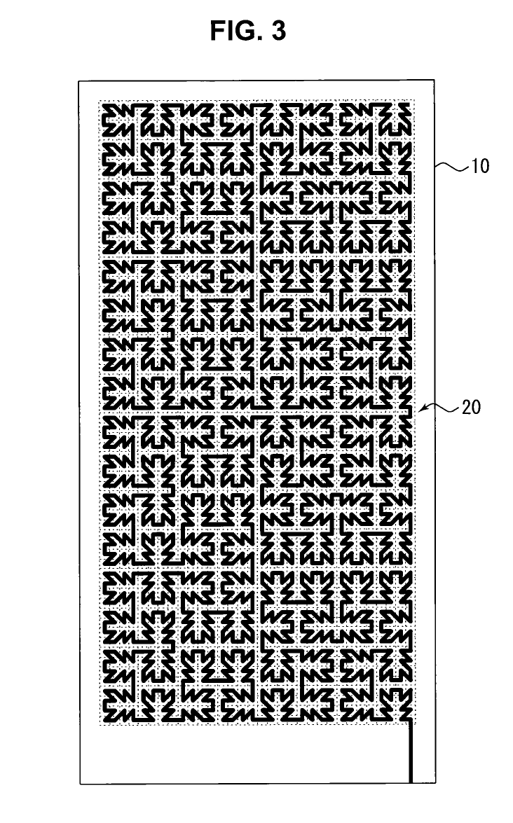

In the vehicle antenna device according to the present invention, such space-filling curves are used to constitute the antenna element. FIG. 3 is a schematic plan view for explaining the antenna element of the vehicle antenna device according to the present invention. In FIG. 3, the unit cells are represented by dotted lines. In the vehicle antenna device according to the present invention, an antenna element 20 is formed on a substrate 10. The substrate 10 is made of a printed circuit board such as a glass-epoxy substrate or a fluorine resin substrate. Alternatively, the substrate 10 may be made of a flexible substrate such as a polyimide film substrate or a polyester film substrate. The antenna element 20 is formed by, for example, patterning a conductive thin film made of copper etc. applied to the substrate 10 by etching into the space-filling curves used in the present invention.

The antenna element shown in FIG. 3 uses two-stage fifth-order space-filling curves. In the present specification, “a stage” means one pattern of the space-filling curves, and “a plurality of stages” means curves obtained by connecting a plurality of the space-filling curves of the one pattern with one another. That is, the “two-stage fifth-order space-filling curves” means space-filling curves obtained by connecting two fifth-order space-filling curve patterns with each other. Although the vehicle antenna device that includes the antenna element having the two-stage fifth-order space-filling curves is shown in FIG. 3, the present invention is not limited to this, but the order number or stage number may suitably be selected according to a desired target frequency (fo). For example, the vehicle antenna device may include an antenna element having one-stage fourth-order space-filling curves as shown in FIG. 2. Alternatively, as shown in FIG. 3, the three-stage fifth-order space-filling curves may be constructed.

According to the vehicle antenna device of the present invention, if the entire length of the antenna element is set to a constant value, the area required for arrangement of the antenna element can be reduced by the amount corresponding to the number of slant lines used as the initial shape and connecting line, thereby reducing the size of the substrate. In other words, if the size of the area required for arrangement of the antenna element is set to a constant value, the length of the antenna element can be increased.

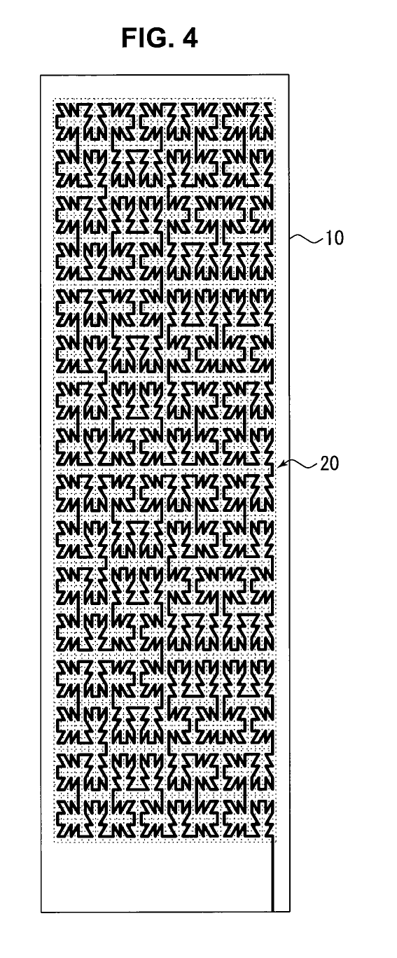

Another example of the vehicle antenna device according to the present invention will be described with reference to FIG. 4. FIG. 4 is a schematic plan view for explaining an example in which the extension factor of the space-filling curves of the antenna element of the vehicle antenna device according to the present invention is made changeable. In FIG. 4, the same reference numerals as those in FIG. 3 denote the same parts as those in FIG. 3. The extension factor of the antenna element shown in FIG. 4 is set to 1.7, i.e., the vertical-to-horizontal ratio of the antenna element is set to 1.7:1. In the present invention, by changing the extension factor of the space-filling curves of the antenna element, a target frequency of the vehicle antenna device can be changed. This is because that the element length is changed by changing the extension factor of the space-filling curves. That is, when the extension factor of the space-filling curves is set to 1.7 as shown in FIG. 4, the element length is correspondingly increased, so that the target frequency becomes lower. Thus, a desired target frequency can be obtained by adjusting the extension factor without the need of increasing or reducing the order number.

The size of the vehicle antenna device is previously determined in general, and the size of a substrate to be used is set in accordance with the determined size of the vehicle antenna device, so that it is only necessary to design an antenna element having space-filling curves obtaining desired characteristics within the size of the substrate.

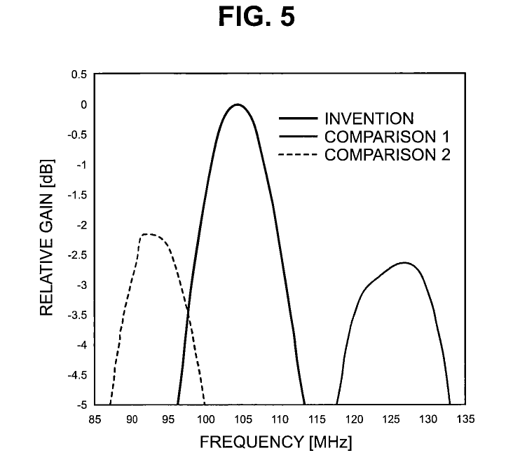

A comparison is made using FIG. 5 between the vehicle antenna device according to the present invention and a conventional antenna device using Hilbert curves. FIG. 5 is a graph showing a frequency-to-gain characteristic obtained by simulation using the vehicle antenna device according to the present invention. As a Comparative Example, a gain characteristic of a conventional antenna device using Hilbert curves is also shown in the graph. Measurement conditions are as follows.

TABLE 1

| | | | Extension |
|---|---|---|---|
| | Line width | Unit cell size | factor |
| Present | 0.65 mm | 1.5 mm | 1.7 |
| Invention | | | |
| Comparative | 0.65 mm | 1.5 mm | 1.0 |
| Example 1 | | | |
| Comparative | 0.65 mm | 1.5 mm | 1.7 |
| Example 2 | | | |

As is clear from FIG. 5, the gain of the vehicle antenna device according to the present invention is much higher than that of the conventional antenna device as a Comparative Example. As can be understood from the gain characteristic of the conventional antenna devices using Hilbert curves as Comparative Examples 1 and 2, the target frequency is changed with a change of the extension factor, and the same is applied to the vehicle antenna device according to the present invention.

Further, in the vehicle antenna device according to the present invention, the gain can be controlled by changing the line width of the space-filling curves of the antenna element. That is, when the line width of the space-filling curves is increased, the gain of the vehicle antenna device according to the present invention becomes higher; and when the line width of the space-filling curves is reduced, the gain thereof becomes lower. Thus, a desired gain can be obtained by changing the line width of the space-filling curves.

Further, in the vehicle antenna device according to the present invention, when the line width of the space-filling curves is increased, a target frequency becomes higher; and when the line width thereof is reduced, a target frequency becomes lower. For example, when the line width of the space-filling curves of the antenna element shown in the condition of FIG. 5 is changed from 0.65 mm to 0.42 mm, the target frequency is changed from about 104 MHz to about 92 MHz.

As described above, in the vehicle antenna device using the space-filling curves according to the present invention, it is possible to reduce the size of the area required for arrangement of the antenna element. Further, the target frequency or gain can be controlled by changing the length (order number or stage number) of the antenna element but also by changing the extension factor or line width thereof.

The vehicle antenna device according to the present invention is not limited to the examples shown in the drawings, but various modifications may be made thereto without departing from the spirit and scope of the invention.

1. A vehicle antenna device in which at least a part of an antenna element is constituted by space-filling curves, the vehicle antenna device comprising:
an antenna element having space-filling curves that initial shape is constituted by two parallel lines and a slant line continuously connecting therebetween.

2. The vehicle antenna device according to claim 1, wherein the antenna element has space-filling curves that initial shape has a start point at one end of the one parallel line and an end point at the other end of the other parallel line.

3. The vehicle antenna device according to claim 1, wherein the antenna element has space-filling curves that initial shape is constituted by an N-shape or reversed N-shape.

4. The vehicle antenna device according to claim 1, wherein the antenna element has slant connecting lines in the space-filling curves.

5. The vehicle antenna device according to claim 1, wherein a target frequency of the antenna element is made changeable by an extension factor of the space-filling curves.

6. The vehicle antenna device according to claim 1, wherein a target frequency of the antenna element is made changeable by a line width of the space-filling curves.

7. The vehicle antenna device according to any of claims 1 to 6, wherein the antenna element has two-stage fifth-order space-filling curves.
